(19) United States
(12) Patent Application Publication
(10) Pub. No.: US 2007/0032136 A1
(43) Pub. Date: Feb. 8, 2007

(54) Card reader

(75) Inventors: Chia-Jui Sheng, Taipei (TW); Ching-Yi Yeh, Taipei (TW); Feng-Yen Lu, Taipei (TW)

Correspondence Address: BACON & THOMAS, PLLC, 625 SLATERS LANE, FOURTH FLOOR, ALEXANDRIA, VA, 22314, US

(73) Assignee: Northstar systems Corporation, Taipei (TW)

(21) Appl. No.: 11/194,665

(22) Filed: Aug. 2, 2005

(51) Int. Cl. H01R 24/00

(52) U.S. Cl. 439/630

(57) ABSTRACT

The present invention is a card reader, which includes an upper case, a lower case, and a printed circuit board. A terminal part and a memory card terminal part are directly formed on the said printed circuit board. Utilizing the structural design of directly forming USB terminal part and memory card terminal part on the printed circuit board, which is different from the method of the conventional card reader that welds various terminal connectors on the printed circuit board, the area used for allocating connectors on printed circuit board is saved, and the manufacturing cost is accordingly decreased.

### BACKGROUND OF THE INVENTION

1) Field of the Invention

The present invention is a card reader, in which USB terminal part and memory card terminal part are directly formed on the printed circuit board, and are further formed into a specified structure on the upper case and lower case of card reader such that memory card can be located in the card reader.

2) Description of the Prior Art

For a variety of electronic devices, memory card has become a major medium for data storage, while the data stored in the memory card is read through a card reader. Apparently, the card reader has significantly affected people's life. In the past, the card reader can be separated into parts such as case, printed circuit board, connector, and integrated circuit device (IC). It thus becomes an issue to find methods to decrease cost of these parts.

A traditional card reader includes printed circuit board, connector, and IC, while the connector and IC are installed on the printed circuit board. Since the connector is a component for connecting electronic equipments or memory cards, the connector is one of the major components in a card reader. Traditionally, after being purchased from manufacturers specialized in producing connector, the connector is welded on the printed circuit board. However, the cost of card reader is difficult to be effectively decreased because neither the purchasing cost of connector nor the processing cost of welding connector on the printed circuit board is capable of effective cost-down, it is unable to promote the competitiveness in the whole card reader market.

### SUMMARY OF THE INVENTION

The major purpose of the present invention is to provide a card reader, in which USB terminal part for connecting USB connector and memory card terminal part for connecting to memory card are directly formed on the printed circuit board, which is different from the way of welding various connectors on the printed circuit board additionally in a traditional card reader.

The minor purpose of the present invention is to provide a structure for locating memory card, which utilizes a structural design of upper opening, lower opening, first slot, second slot, such that memory cards with distinct specifications can be easily embedded in a card reader.

To further describe the technical details of the present invention, the illustrative matter together with the accompanying drawings are described in the following.

### BRIEF DESCRIPTION OF THE DRAWINGS

FIG. 1 shows the assembly drawing according to the present invention.

FIG. 2 shows a disassembled upper case and lower case according to the present invention.

FIG. 3 is a pictorial drawing showing the printed circuit board according to the present invention.

FIG. 4A shows a top view of the printed circuit board according to the present invention.

FIG. 4B shows a side view of the printed circuit board according to the present invention.

FIG. 5A is a pictorial drawing showing assembling the printed circuit board to an SD memory card according to the present invention.

FIG. 5B is a side view showing assembling the printed circuit board to an SD memory card according to the present invention.

FIG. 6A is a pictorial drawing showing assembling the printed circuit board to an MMC memory card according to the present invention.

FIG. 6B is a side view showing assembling the printed circuit board to an MMC memory card according to the present invention.

### DETAILED DESCRIPTION OF THE PREFERRED EMBODIMENTS

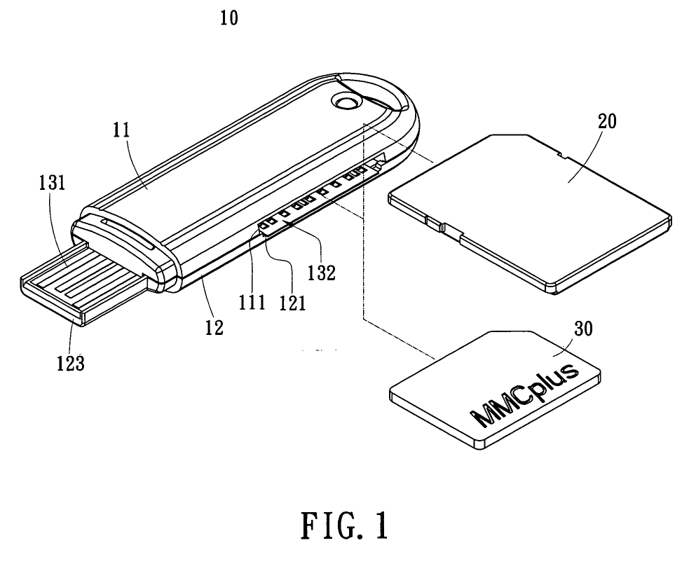

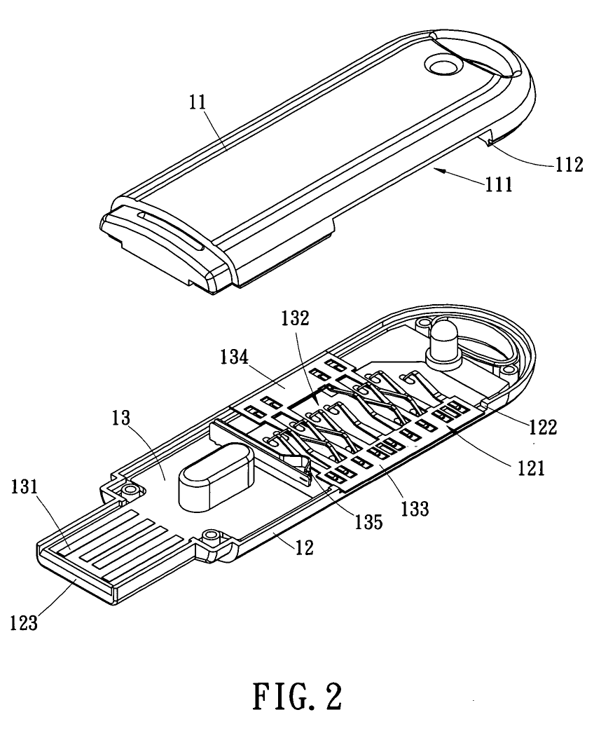

Referring to FIG. 1 and FIG. 2, the card reader 10 according to the present invention include an upper case 11, a lower case 12, and a printed circuit board 13, in which the upper and lower cases 11, 12 can be assembled to each other to become a case, and on the upper, lower cases 11, 12 a pair of upper, lower openings 111, 121 are separately provided to correspond to each other, where the diameter of the upper opening 111 is slightly larger than that of the lower opening 121. Further, a first slot 112 is formed on the upper opening 111 for accepting insertion of SD memory card 20, and a second slot 122 is formed on the lower opening 121 for accepting insertion of MMC memory card 30. Besides, the lower case 12 is longer than the upper case 11 and thus forms a convex part 123 while the specification of convex part 123 corresponds to the specification of USB connector.

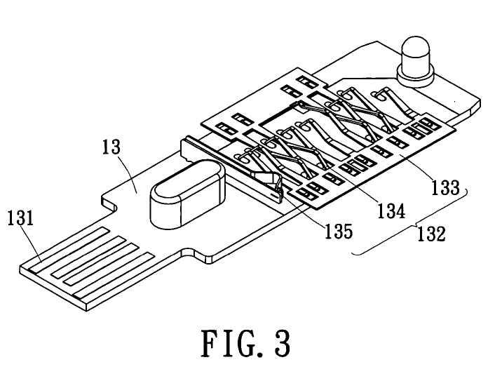

The printed circuit board 13 is situated inside the upper, lower cases 11, 12. On the printed circuit board 13 an USB terminal part 131 and a memory card terminal part 132 are provided. The USB terminal part 131 is formed at one side of the printed circuit board 13 and is situated inside the convex part 123. The memory card terminal part 132 is situated on the printed circuit board 13 and its location corresponds to the upper, lower openings 111, 121. In FIG. 3, the memory card terminal part 132 further includes a first conducting terminals 133, a second conducting terminals 134, and a locating spring arm 135, where the first conducting terminals 133 and the second conducting terminals 134 are interleaved, and the locating spring arm 135 is situated beside the first conducting terminals 133 and the second conducting terminals 134

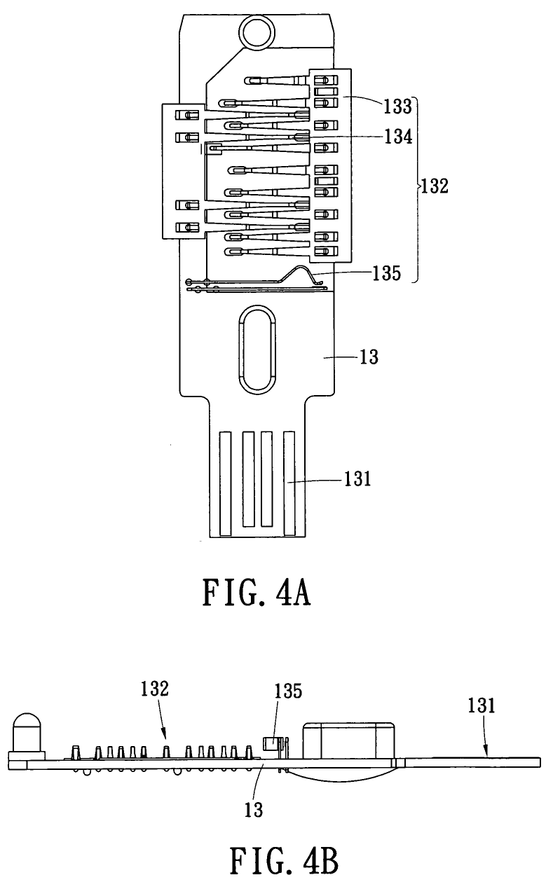

Further, referring to FIGS. 4A and 4B, where the printed circuit board 13 according to the present invention is formed with an USB terminal part 131 at one side. The width of the said side is slightly smaller than the width of the printed circuit board 13 and, in the same way, corresponds to the specification of USB connector.

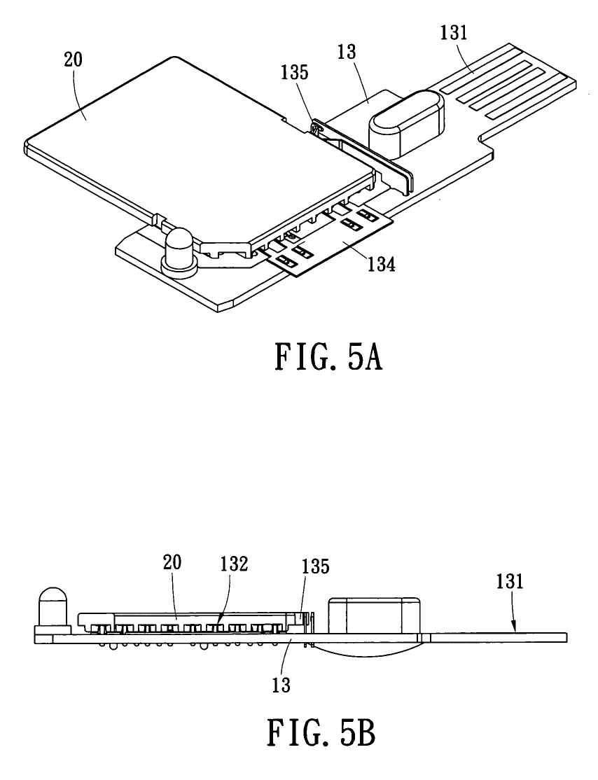

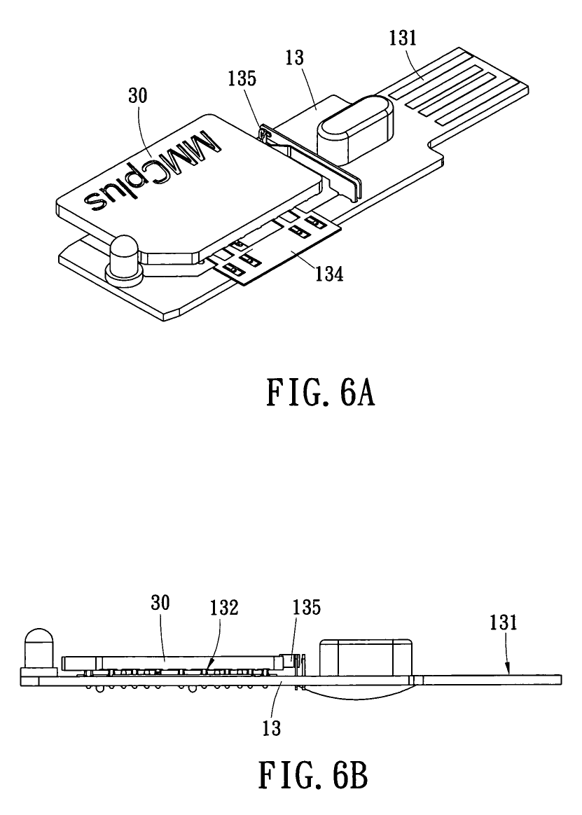

Furthermore, referring to FIGS. 5A, 5B, 6A, and 6B, where the printed circuit board 13 according to the present invention corresponds to memory cards of distinct specifications. When an SD memory card 20 is inserted into the first slot 112 through the first opening 111 (as shown in FIG. 1) and is blocked at the pre-defined position on the printed circuit board 13, the locating spring arm 135 is latched at the lateral convex portion of the SD memory card 20 and thus achieves the purpose of locating. In the meantime, the first conducting terminal 133 and the second conducting terminal 134 separately conducts to the corresponding terminal of SD memory card 20, the connection between SD memory card 20 and the printed circuit board 13 is thus completed and the procedure of card reading follows.

Moreover, referring to FIGS. 6A and 6B, which show the form of matching printed circuit board 13 to the MMC memory card 30. When an MMC memory card 30 is inserted into the second slot 122 through the second opening 121 (as shown in FIG. 1) and is blocked at the pre-defined position on the printed circuit board 13, the locating spring arm 135 is pressed against the lateral of the MMC memory card 30 and is thus achieve the purpose of locating. In the meantime, the first conducting terminal 133 and the second conducting terminal 134 separately conducts to the corresponding terminal of MMC memory card 30, the connection between MMC memory card 30 and the printed circuit board 13 is completed, and the procedure of card reading goes after.

Following the above description, the structural design of directly forming USB terminal part and memory card terminal part on the printed circuit board not only saves the area of allocating connector on the printed circuit board, but promptly decreases the manufacturing cost as well.

1. A card reader, which includes:
an upper case, on which an upper opening is provided;
a lower case, which can be assembled to the said upper case and, on which a lower opening that corresponds to the said upper opening is provided; and
a printed circuit board, which is situated inside the upper and lower cases, and which includes a USB terminal part as well as a memory card terminal part, where the USB terminal part is formed on one side of the printed circuit board, while the memory card terminal part is installed on the printed circuit board at a location corresponding to the upper and lower openings.

2. A card reader in accordance with claim 1, wherein the lower case further includes a convex part, which is formed at one side of the said upper case, and the said USB terminal part is situated inside the convex part.

3. A card reader in accordance with claim 1, wherein the said memory card terminal part further includes:
first conducting terminals;
second conducting terminals, which are interleaved with the said first conducting terminals; and
a locating spring arm, which is situated at the laterally of the first conducting terminals and the second conducting terminals, said locating spring arm arranged to laterally engage different types of memory cards, and locate the cards relative to the first and second conducting terminals.

4. A card reader in accordance with claim 2, wherein dimensions of the said convex part correspond to dimensions of a USB connector.

5. A card reader in accordance with claim 1, wherein the diameter of the upper opening is slightly larger than the diameter of the lower opening.

6. A card reader in accordance with claim 1, wherein the diameter of the upper opening includes a first slot for accepting the insertion of an SD memory card.

7. A card reader in accordance with claim 1, wherein the diameter of the lower opening includes a second slot for accepting the insertion of an MMC memory card.
